(19) United States
(12) Patent Application Publication
(10) Pub. No.: US 2025/0086637 A1
(43) Pub. Date: Mar. 13, 2025

(54) ELECTRONICALLY COMMUNICATING CONTACT INFORMATION AFTER AUTHORIZED INTERACTION

(71) Applicant: MASTERCARD TECHNOLOGIES CANADA ULC, Vancouver (CA)

(72) Inventors: Kyle Williams, Wentzville, MO (US); Jonathan McGrandle, Maple Ridge (CA); Matthew Melnik, Delta (CA)

(21) Appl. No.: 18/826,360

(22) Filed: Sep. 6, 2024

Related U.S. Application Data
(60) Provisional application No. 63/581,130, filed on Sep. 7, 2023.

(51) Int. Cl. G06Q 20/40

(52) U.S. Cl. CPC G06Q 20/4016; G06Q 20/409

(57) ABSTRACT

A system for communicating cardholder data. The system comprises a remuneration vehicle device, a third-party entity device, and a server. The remuneration vehicle device includes a first communication interface, a first electronic processor, and a first memory. The third-party entity device includes a second communication interface, a second electronic processor, and a second memory. The server includes a third communication interface, a third electronic processor, and a third memory. The third electronic processor is configured to receive, with the third communication interface, a first data packet indicating cardholder data from the first communication interface, store the cardholder data in the third memory, receive a second data packet indicating a transaction request from the second communication interface, and provide a third data packet indicating a transaction response to the second communication interface. The third data packet includes the cardholder data from the third memory.

### CROSS-REFERENCE TO RELATED APPLICATION

This application claim priority to, and the benefit of, U.S. Provisional Application No. 63/581,130, filed on Sep. 7, 2023, the entire contents of which are incorporated herein by reference.

### FIELD OF THE INVENTION

The present disclosure relates generally to electronic communications. More specifically, the present disclosure relates to systems, methods, and non-transitory computer-readable media for electronically communicating contact information from a remuneration vehicle issuer to a third-party entity after an authorized interaction between the remuneration vehicle and the third-party entity.

### BACKGROUND

Third-party entities face a significant challenge in detecting chargeback fraud which occurs either as a third-party fraud or a first-party fraud. For example, third-party fraud may occur when someone other than a remuneration vehicle owner places a transaction, the remuneration vehicle owner subsequently reports the transaction as fraudulent, and requests a chargeback. A third-party entity is burdened with detecting that the third-party fraud is occurring before a transaction is placed.

As another example, first-party fraud may occur when the remuneration vehicle owner places a transaction, subsequently reports the transaction as fraudulent, and request a chargeback. A third-party entity is burdened with proving that the remuneration vehicle owner placed the transaction. During chargeback fraud, a third-party entity experiences fraud losses through lost merchandise, refunding the transaction amount, and overhead in handling the fraudulent transaction (e.g., costs associated with the investigation and the resolution).

Third-party entities also face a significant challenge in providing environmentally friendly receipts, as receipts are typically made of paper. Paper receipts must be printed which slows down a transaction and leads to many third-party entities disposing of the printed receipts. Many remuneration vehicle owners lose track of their receipt, complicating a return process. In addition, third-party entities face a significant challenge in enrolling remuneration vehicle owner in reward programs. For example, a remuneration vehicle owner may be tasked with filling out a time-consuming form for the third-party entity to obtain their contact information.

### SUMMARY

Various embodiments of the present disclosure recognize that challenges exist in communicating cardholder contact information to a merchant and that there are no specific solutions for quick obtainment of cardholder contact information by a merchant. In fraud prevention instances, providing cardholder contact information to a merchant at the time of authorization provides the merchant with an opportunity to pro-actively reach out to a cardholder. For example, with third-party fraud, the merchant may place the order on hold until the cardholder authorizes a transaction or flags the transaction as fraudulent. As another example, with first-party fraud, the merchant may place the order on hold until the cardholder authorizes a transaction and the merchant may keep a record that the transaction was authorized in the case that a cardholder attempts to dispute the transaction.

Communicating cardholder contact information to a merchant is also beneficial for transaction receipts and merchant reward programs. A merchant is able to provide an automated receipt to a cardholder via email or text message when the merchant has the cardholder's contact information. Providing a cardholder with an automated receipt without the cardholder having to directly provide their contact information to the merchant greatly improves the cardholder's experience and reduces an impact on the environment. Enrollment in a merchant reward program is expedited when the merchant is able to obtain cardholder contact information. In some instances, after cardholder consent, enrollment may be automatic when the merchant has access to cardholder contact information during a transaction.

Various embodiments of the present disclosure solve the challenges associated with a merchant obtaining a cardholder's contact information during a transaction for fraud prevention, automated receipts, and rewards program enrollment. In some embodiments, a cardholder's issuer may collect cardholder information from the cardholder for use with merchants and subsequently provide the cardholder's contact information to the merchant when the merchant communicates a transaction with the cardholder to the issuer. In some embodiments, the merchant may use the cardholder's contact information to contact the cardholder to confirm a transaction, provide an automated transaction receipt, and enroll the cardholder in a rewards program.

One embodiment herein is a system for communicating cardholder data. The system comprises a remuneration vehicle device, a third-party device, and a server. The remuneration vehicle device includes a first communication interface, a first electronic processor, and a first memory. The third-party device includes a second communication interface, a second electronic processor, and a second memory. The server includes a third communication interface, a third electronic processor, and a third memory. The third electronic processor is configured to receive, with the third communication interface, a first data packet indicating cardholder data from the first communication interface, store the cardholder data in the third memory, receive, with the third communication interface, a second data packet indicating a transaction request from the second communication interface, and provide, with the third communication interface, a third data packet indicating a transaction response to the second communication interface. The third data packet includes the cardholder data from the third memory.

A further embodiment herein is a method for communicating cardholder data from a server to a third-party device. The method includes receiving, with a communication interface of the server, a first data packet from a communication interface of a remuneration vehicle device, storing, with an electronic processor of the server, the first data packet in a memory of the server, receiving, with the communication interface of the server, a second data packet from a communication interface of the third-party device, and providing, with the communication interface of the server, a third data packet to the communication interface of the third-party device. The third data packet includes the first data packet and additional data from the memory of the server.

An even further embodiment herein is a non-transitory computer-readable medium comprising instructions for communicating cardholder data to a third-party device that, when executed by an electronic processor, cause the electronic processor to perform a set of operations. The set of operations comprises receiving, with a communication interface of a payment processor server coupled to the electronic processor, a first data packet from a communication interface of the third-party device, providing, with the communication interface of the payment processor server, the first data packet to a communication interface of an issuer server, receiving, with the communication interface of the payment processor server, a second data packet from the communication interface of an issuer server, and providing, with the communication interface of the payment processor server, a third data packet to the communication interface of the third-party device. The third data packet includes the second data packet and additional data associated with the issuer server stored in a memory of the payment processor server.

Other aspects of the invention will become apparent by consideration of the detailed description and accompanying drawings.

### BRIEF DESCRIPTION OF THE DRAWINGS

FIG. 1 is a block diagram illustrating an example system for electronically communicating contact information to a third-party entity, in accordance with various aspects of the present disclosure.

FIG. 2 is a block diagram of example devices for use in the example system of FIG. 1, in accordance with various aspects of the present disclosure.

FIG. 3 schematically illustrates an example communication or data flow for identifying usage of the example system of FIG. 1, in accordance with various aspects of the present disclosure.

FIG. 4 is a flow diagram illustrating an example process for saving cardholder contact information in an issuer server, in accordance with various aspects of the present disclosure.

FIG. 5 is a flow diagram illustrating an example process of a transaction, in accordance with various aspects of the present disclosure.

FIG. 6 is a flow diagram illustrating an example process of providing an authorization from an issuer server to a merchant device, in accordance with various aspects of the present disclosure.

FIG. 7 is a flow diagram illustrating an example process of providing a transaction confirmation to a cardholder device for fraud prevention, in accordance with various aspects of the present disclosure.

FIG. 8 is a flow diagram illustrating an example process of providing a transaction receipt to a cardholder device, in accordance with various aspects of the present disclosure.

FIG. 9 is a flow diagram illustrating an example process of enrolling a cardholder in a rewards program, in accordance with various aspects of the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

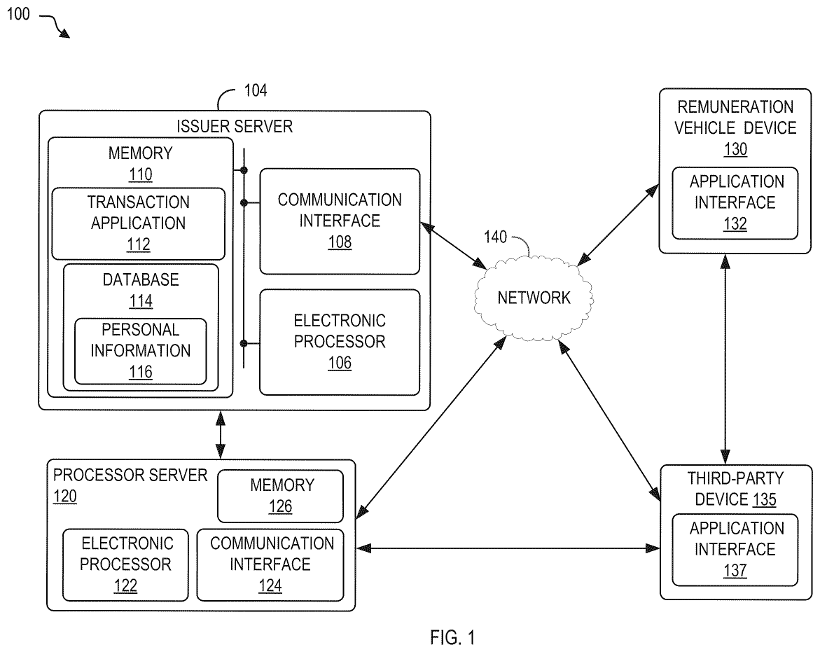

FIG. 1 is a block diagram illustrating an example system for automatically communicating cardholder contact information to a merchant, in accordance with various aspects of the present disclosure. It should be understood that, in some embodiments, there are different configurations from the configuration illustrated in FIG. 1. The functionality described herein may be extended to any number of servers providing distributed processing.

In the example of FIG. 1, the system 100 includes an issuer server 104, a processor server 120, a remuneration vehicle device 130, a third-party entity device 135, and a network 140. In some examples, the issuer server 104 may be owned by, or operated by or on behalf of, a remuneration vehicle issuer (e.g., the issuer of a credit/debit card).

The issuer server 104 includes an electronic processor 106, a communication interface 108, and a memory 110. The electronic processor 106 is communicatively coupled to the communication interface 108 and the memory 110. The electronic processor 106 is a microprocessor or another suitable processing device. The communication interface 108 may be implemented as one or both of a wired network interface and a wireless network interface. The memory 110 is one or more of volatile memory (e.g., RAM) and non-volatile memory (e.g., ROM, FLASH, magnetic media, optical media, etc.). In some examples, the memory 110 is also a non-transitory computer-readable medium. Although shown within the issuer server 104, memory 110 may be, at least in part, implemented as network storage that is external to the issuer server 104 and accessed via the communication interface 108. For example, all or part of memory 110 may be housed on the “cloud.”

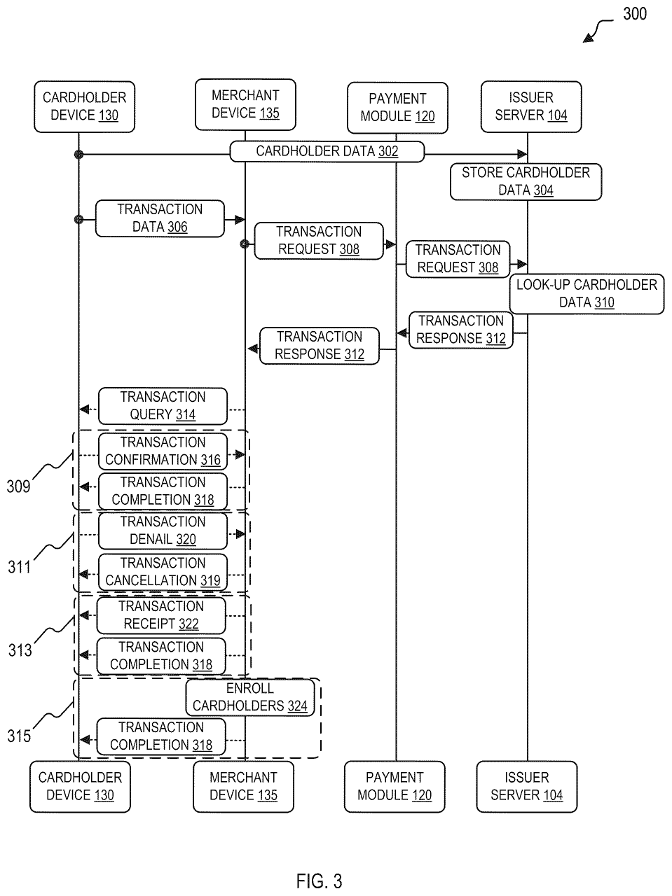

A remuneration application 112 (referred to hereinafter as “transaction application 112”) and a database 114 may be stored in the memory 110. In some embodiments, the transaction application 112 may include machine readable instructions that are executed by the electronic processor 106 to perform the functionality of the issuer server 104 as described below with respect to FIGS. 3, 4, and 6. The database 114 may store personal information 116 received from the remuneration vehicle device 130. For example, personal information 116 may include at least one of the cardholder's name, email, phone number (e.g., mobile, phone, and work), and other suitable contact information (e.g., messaging application contact information). In some embodiments, the database 114 may be a Resource Description Framework (RDF) database or a Structured Query Language (SQL) database (e.g., a knowledge graph). The database 114 may include a plurality of personal information 116 associated with various cardholders.

The processor server 120 (referred to hereinafter as “payment server 120) may be a server computer or a web-compatible mobile computer, such as a laptop, a tablet, a smart phone, or other suitable computing device. Alternately, or in addition, the payment server 120 may be a desktop computer. The payment server 120 may be owned by, or operated by or on behalf of, a payment network (e.g., credit card company). The payment server 120 includes an electronic processor 122 in communication with a communication interface 124 and memory 126. The electronic processor 122 is a microprocessor or another suitable processing device, the memory 126 is one or more of volatile memory and non-volatile memory, and the communication interface 124 may be a wireless or wired network interface. In some embodiments, the memory 126 of the payment server 120 may include the database 114 that stores cardholder personal information 116.

An application, which contains software instructions implemented by the electronic processor 122 of the payment server 120 to perform the functions of the payment server 120 as described herein, is stored within a transitory or a non-transitory portion of the memory 126. In some embodiments, the payment server 120 utilizes the application to create a secure connection between a computing device (e.g., remuneration vehicle device 130 or third-party entity device 135) and a server (e.g., issuer server 104 or payment server 120), or between two networks, using an insecure communication medium such as the public Internet. In some embodiments, communication between the third-party entity device 135 and the issuer server 104 goes through the payment server 120. For example, the third-party entity device 135 may initiate a transaction request (e.g., a transaction data packet) to the issuer server 104 (e.g., after receiving a transaction inquiry from the remuneration vehicle device 130) and the payment server 120 may add additional information to a transaction response (e.g., additional data elements added to the transaction data packet) before the third-party entity device 135 receives the transaction response from the issuer server 104. The additional data elements added to the transaction data packet may include issuer contact information, cardholder personal information 116, or any other information stored in the memory 110 of the issuer server 104 or the memory 126 of the payment server 120.

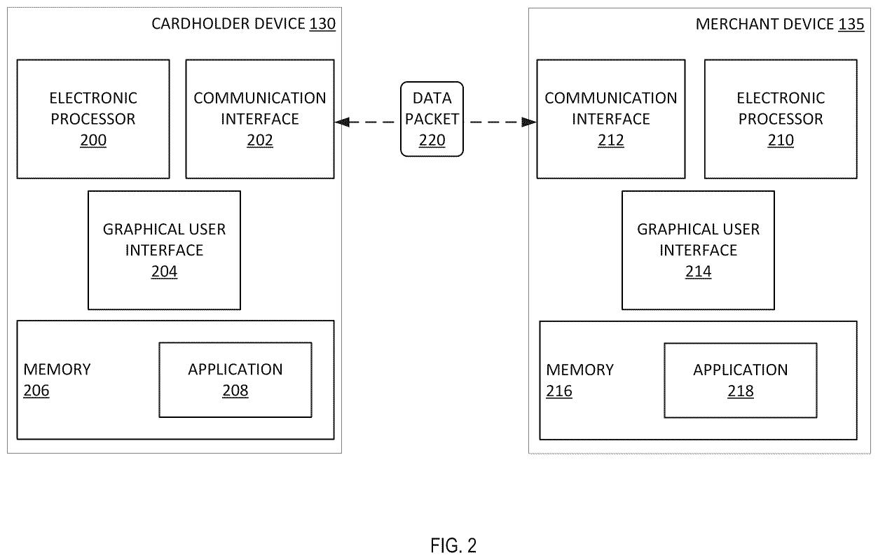

The remuneration vehicle device 130 (referred to hereinafter as “cardholder device 130”) may be a mobile device such as a laptop, a tablet, a smart phone, or other suitable computing device. Alternatively, or in addition, the cardholder device 130 may be a desktop computer. The cardholder device 130 may include an application interface 132. The application interface 132 facilitates interaction with an application, such as application 208 (FIG. 2), which contains software instructions implemented by an electronic processor of the cardholder device 130, such as electronic processor 200 (FIG. 2), to perform the functions of the cardholder device 130 as described herein, is stored within a transitory or a non-transitory portion of a memory, such as memory 206 (FIG. 2). The application may have a graphical user interface that facilitates interaction between a user/cardholder and the cardholder device 130. For example, the application interface 132 is a front-end application of the issuer server 104 or the payment server 120. The cardholder device 130 will be described in detail below with respect to FIG. 2.

The cardholder device 130 may communicate (e.g., send a data packet) with the issuer server 104, the payment server 120, and the third-party entity device 135 over the network 140. The network 140 is preferably (but not necessarily) a wireless network, such as a wireless personal area network, local area network, or other suitable network. In some examples, the cardholder device 130 may directly communicate with the issuer server 104. In other examples, the cardholder device 130 may indirectly communicate with the issuer server 104 over the network 140. In some embodiment, the network 140 may be encrypted. Alternatively, or additionally, in some embodiments, data communicated between the cardholder device 130 and the issuer server 104, the payment server 120, and the third-party entity device 135 may be encrypted based on instructions from the application.

The third-party entity device 135 (referred to hereinafter as “merchant device 135”) may be a mobile device such as a laptop, a tablet, a smart phone, or other suitable computing device. Alternatively, or in addition, the merchant device 135 may be a desktop computer. The merchant device 135 may include an application interface 137. The application interface 137 facilitates interaction with an application, which contains software instructions implemented by an electronic processor of the merchant device 135 to perform the functions of the merchant device 135 as described herein, that is stored within a transitory or a non-transitory portion of a memory. The application may have a graphical user interface that facilitates interaction between a user/merchant and the merchant device 135. For example, the application interface 137 is a front-end application of the issuer server 104 or the payment server 120. The merchant device 135 may communicate with the issuer server 104, the payment server 120, and the cardholder device 130 over the network 140. In some embodiments, data communicated between the merchant device 135 and the issuer server 104, the payment server 120, and the cardholder device 130 may be encrypted based on instructions from the application.

FIG. 2 is a block diagram of communication between an example cardholder device, such the cardholder device 130, and an example merchant device, such as merchant device 135, in accordance with various aspects of the present disclosure. As mentioned above, the cardholder device 130 may be a mobile device such as a laptop, a tablet, a smart phone, or other suitable computing device. The cardholder device 130 includes an electronic processor 200, a communication interface 202, a graphical user interface (“GUI”) 204, and a memory 206. The memory 206 may store an application 208. The electronic processor 200 may execute the instructions of the application 208 based on input to the application interface 132 that is a part of the GUI 204. In some embodiments, the application 208 includes a database with the renumeration vehicle's personal information 116 (referred to hereinafter as “cardholder personal information 116”). For example, the database may store a cardholder's name, email, phone number (e.g., mobile, phone, and work), address, renumeration vehicle information (e.g., credit card number, expiration date, security code) and birthdate. In some embodiments, the application 208 imports the information from another part of the memory 206. In addition to storing the application 208, the memory 206 may be configured to store data and/or instructions that may be executable by the electronic processor 200. For example, the memory 206 may be a random access memory (“RAM”).

The electronic processor 200 may facilitate communication between the communication interface 202 and the GUI 204. In some embodiments, based on input to the GUI 204, the electronic processor 200 may execute the application 208 to send a data packet 220, via the communication interface 202, to at least one of the issuer server 104, the payment server 120, and the merchant device 135. For example, the electronic processor 200 may provide a data packet 220 including the cardholder's personal information 116 to the issuer server 104 or the payment server 120 via the communication interface 202 when a user interacts with the GUI 204 by, for example, inputting the personal information 116 for the first time, updating the personal information 116, or authorizing the personal information 116 to be sent to the issuer server 104. In particular, the electronic processor 200 may provide the data packet to the memory 110 of the issuer server 104 via the communication interface 108 of the issuer server 104. As another example, the electronic processor 200 may provide a data packet 220 including transaction data to the merchant device 135 when a user interacts with the GUI 204 by, for example, purchasing a good off a merchant's website or using a mobile payment device (e.g., mobile credit card) to place an order in a merchant's store. In particular, the electronic processor 200 may provide the cardholder's credit card information (e.g., credit card number, expiration date, security code, and cardholder's name) to the merchant device 135.

In some embodiments, the electronic processor 200 may execute the application 208 that provides the cardholder with an interactive option at the GUI 204 based on received data via the communication interface 202. For example, the merchant device 135 may provide the communication interface 202 with a data packet 220 including a transaction query that solicits a response from the cardholder (e.g., a response that is an input at the GUI 204). The transaction query may be one of a text message, email, or pop-up on the GUI 204 provided by the electronic processor 200 executing the application 208. In some embodiments, the communication interface 202 is Bluetooth® enabled. Alternatively, or additionally, the communication interface 202 includes cellular communication capabilities and/or WiFi capabilities. In some embodiments, the communication interface 202 includes a physical port that receives an ethernet port.

The merchant device 135 may be similar to the cardholder device 130. For example, the merchant device 135 may include an electronic processor 210, a communication interface 212, a GUI 214, and a memory 216. The GUI 214 may include the application interface 137. The memory 216 may store an application 218 and the electronic processor 210 may execute instructions of the application 218 based on input at the application interface 137. In some embodiments, the memory 206 may be a random access memory (“RAM”).

The electronic processor 210 may facilitate communication between the communication interface 212 and the GUI 214. In some embodiments, based on input to the GUI 214, the electronic processor 210 may execute the application 218 to send a data packet 220, via the communication interface 212 to at least one of the issuer server 104, the payment server 120, and the cardholder device 130. For example, the electronic processor 210 may provide a data packet 220 including a transaction request to the payment server 120 via the communication interface 212 when the communication interface 212 receives transaction data from a cardholder device 130.

FIG. 3 is a flow diagram illustrating an example communication or data flow for identifying usage of the example system of FIG. 1, in accordance with various aspects of the present disclosure. In the example of FIG. 3, a communication environment 300 includes the cardholder device 130, the merchant device 135, the payment server 120, and the issuer server 104. The communication environment 300 includes a set of data packets 220 including transaction information transmitted in the process of a merchant device 135 automatically receiving cardholder information from the payment server 120 during a transaction.

In one embodiment, the cardholder device 130 provides cardholder data 302 to the issuer server 104. For example, cardholder data 302 includes the cardholder's personal information 116 (e.g., the cardholder's name, email, phone number (e.g., mobile, phone, and work), messaging application contact information, address, renumeration vehicle information (e.g., credit card number, security code, expiration date, etc.), birthdate, preferred contact method (e.g., phone or email), receipt preference (e.g., electronic, paper, or both), reward program preferences (e.g., auto-enroll or do not auto-enroll) and the like). In some embodiments, a cardholder inputs the cardholder data 302 at the GUI 204. The issuer server 104 stores the cardholder data 304 upon receipt of the cardholder data 302. For example, the issuer server 104 may store the cardholder data 304 in the database 114. Alternatively, or additionally, in some embodiments, the cardholder device 130 provides the cardholder data 302 to the payment server 120 and the payment server 120 stores the cardholder data 304.

The cardholder device 130 may also provide transaction data 306 to the merchant device 135. For example, transaction data 306 may include an item purchased identifier, credit card information (e.g., credit card number, expiration date, security code, and cardholder's name), cardholder device 130 location, and shipping preferences (e.g., shipping time preference and address). In some embodiments, the transaction data 306 is provided by the cardholder device 130 to the merchant device 135 in response to a user interacting with a transaction platform provided on the GUI 204 of the cardholder device 130. In some embodiments, transaction data 306 is input directly into the merchant device 135. For example, a cardholder may place a purchase in store and merchant may directly input the transaction data 306 in to the merchant device 135 via the GUI 214 of the merchant device 135.

The merchant device 135 may provide a transaction request 308 to the payment server 120. In some embodiments, the transaction request 308 may include the transaction data 306 and an authorization request. For example, the authorization request may be request that inquires whether the cardholder has sufficient funds (e.g., bank account available balance or available credit limit) to purchase the item and the cardholder's personal information 116. The payment server 120 may process the transaction request 308 and forward the transaction request 308 to the issuer server 104. The issuer server 104 may look-up cardholder data 310 associated with the transaction request 308. For example, based on the transaction data 306, the issuer server 104 may access cardholder data 302 stored in the database 114. The issuer server 104 may match one of the credit card number, expiration date, security code, and cardholder's name (e.g., the transaction data 306) to at least some of the cardholder data 302.

In some embodiments, when the payment server 120 stores the cardholder data 304, the transaction request 308 may not be provided to the issuer server 104 by the payment server 120. Rather, the payment server 120 may look-up the cardholder data 310 in the memory 126 of the payment server 120.

The issuer server 104 may provide a transaction response 312 to the payment server 120. For example, the transaction response 312 may include the cardholder's personal information, an authorization request response, and a notice that the cardholder has sufficient funds for the item. In some embodiments, the transaction response 312 is encrypted. In some embodiments, the cardholder's personal data may be a sub-element under the authorization request response in the transaction response 312 that ensures predetermined security and encryption are applied the cardholder's personal information. The payment server 120 may provide the transaction response 312 to the merchant device 135. In some embodiments, the payment server adds additional data to the transaction response 312 before sending the transaction response 312 to the merchant device 135. For example, the payment server 120 may automatically add the cardholder's contact information (e.g., phone number, email, or mailing address) renumeration vehicle information (e.g., credit card number, security code, expiration date, etc.) to the transaction response. Alternatively, or additionally, in some embodiments, the issuer server 104 may include the additional data as a part of the transaction response 312. In some embodiments, the merchant device 135 decrypts the transaction response 312 (e.g., when the transaction response 312 is encrypted) using Advanced Encryption Standard (AES) decryption techniques or other suitable decryption techniques.

The merchant device 135 may provide a transaction query 314 to the cardholder device 130. For example, the merchant device 135 may provide the transaction query 314 via one of an email, text message, phone call, or direct message on a web platform based on the cardholder's personal information received with the transaction response 312. In some embodiments, the transaction query 314 provides the cardholder device 130 with a question pertaining to the legitimacy of the transaction data 306. For example, when the cardholder device 130 receives the transaction query 314, the cardholder device 130 may provide a confirmation (e.g., a window asking “Did You Place this Transaction?” and including at least some of the transaction data 306) at the GUI 204 in the form of an interactive element (e.g., the window including “YES” or “NO” interactive button).

During a no-fraud communication 309, the cardholder device 130 may provide a transaction confirmation 316 to the merchant device 135. For example, the cardholder device 130 may receive a confirmatory interaction (e.g., selection of the “YES” interactive button) at the GUI 204 and the communication interface 202 may communicate the transaction confirmation 316 to the merchant device 135. The merchant device 135 may provide a transaction completion 318 to the cardholder device 130. For example, the transaction completion 318 may include a confirmation that the transaction was placed. In some embodiments, the transaction completion 318 may include data that ends any further communication between the merchant device 135 and the cardholder device 130 with respect to the transaction.

During a fraud communication 311, the cardholder device 130 may provide a transaction denial 320 to the merchant device 135. For example, the cardholder device 130 may receive a denial interaction (e.g., selection of the “NO” interactive button) at the GUI 204 and the communication interface 202 may communicate the transaction denial 320 to the merchant device 135. The merchant device 135 may provide a transaction cancellation 319 to the cardholder device 130. For example, the transaction cancellation 319 may include a confirmation the transaction was not placed. The merchant device 135 may determine that the transaction data 306 included fraudulent data based on the transaction denial 320.

During a receipt communication 313, the merchant device 135 may provide a transaction receipt 322 to the cardholder device 130. For example, the transaction receipt 322 may be an electronic receipt detailing the transaction data 306 received by the merchant device 135. In some embodiments, the transaction receipt 322 is provided to the cardholder device 130 in the form of an email (e.g., the cardholder's email address may be provided to the merchant device 135 via the transaction response 312). In some embodiments, the transaction receipt 322 will be provided by the merchant device 135 without the merchant device 135 providing a transaction query 314. The merchant device 135 may provide a transaction completion 318 to the cardholder device 130.

During a rewards program enrollment communication 315, the merchant device 135 may enroll the cardholder in a rewards program. For example, based on the transaction response 312 including data relating to the cardholder's rewards program preferences and the cardholder's personal information 116 (e.g., as communicated via the cardholder data 302), the merchant device 135 may automatically enroll the cardholder in the rewards program 324. In some embodiments, the merchant device 135 may automatically enroll the cardholder in the rewards program 324 without the merchant device 135 providing a transaction query 314. The merchant device 135 may provide a transaction completion 318 to the cardholder device 130.

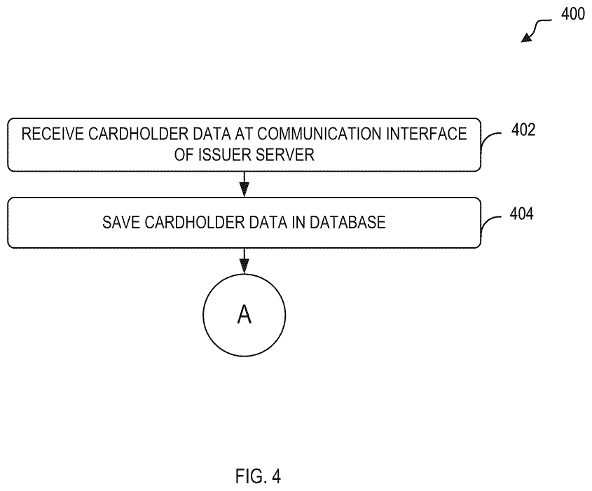

FIG. 4 is a flow diagram illustrating an example process 400 for saving cardholder contact information to an issuer server, such as issuer server 104, in accordance with various aspects of the present disclosure. In the example of FIG. 4, the process 400 is described in a sequential flow, however, some of the process 400 may also be performed in parallel. It is understood that the process 400 may be stored in a memory, such as memory 110 of the issuer server 104, and executed by a processor, such as electronic processor 106. Accordingly, while the process 400 is described in regards to the issuer server 104, it is contemplated that the process 400 may be at least partially performed alternatively or additionally by the payment server 120.

The communication interface 108 receives cardholder data from a cardholder device (block 402). For example, the communication interface 108 of the issuer server 104 receives a first data packet including and indicating cardholder data 302 from the cardholder device 130, via the communication interface 202 of the cardholder device 130. In some embodiments, a cardholder inputs their personal information at the GUI 204 of the cardholder device 130 when the electronic processor 200 executes the application 208 and the electronic processor 200 further executes the application 208 to collect the personal information and creates the first data packet (e.g., cardholder data 302) for transmission by the communication interface 202 that includes the personal information. The electronic processor 106 saves the cardholder data in a database (block 404). For example, the electronic processor 106 saves the cardholder data 302 as personal information 116 in the database 114 in the memory 110 of the issuer server 104. The process 400 continues to example process 500.

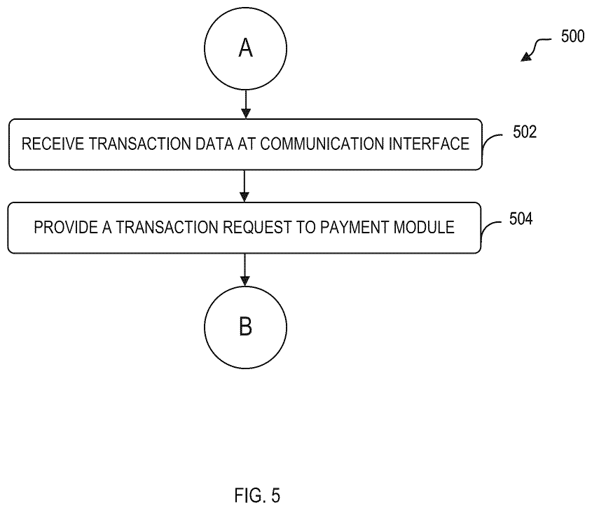

FIG. 5 is a flow diagram illustrating example process 500 of a transaction, in accordance with various aspects of the present disclosure. In the example of FIG. 5, the process 500 is described in a sequential flow, however, some of the process 500 may also be performed in parallel. It is understood that the process 500 may be stored in a memory, such as memory 216 of the merchant device 135, and executed by a processor, such as electronic processor 210 of the merchant device 135. Accordingly, the process 500 is described in regards to merchant device 135. In some embodiments, the process 500 may be executed in conjunction with or in response to the steps of process 400.

The communication interface 202 of the merchant device 135 receives transaction data (block 502). For example, the communication interface 202 receives a second data packet including and indicating the transaction data 306 from the cardholder device 130, via the communication interface 202 of the cardholder device 130. In some embodiments, a cardholder inputs credit card information into a transaction platform displayed on the GUI 214 of the cardholder device 130 by the electronic processor 210 executing the application 218 and the electronic processor 210 collects the credit card information by further executing the application 218 and creates the second data packet (e.g., the transaction data 306) for transmission by the communication interface 202 that includes the credit card information. The communication interface 202 of the merchant device 135 provides a transaction request to a payment server (block 504). For example, the transaction request 308 is provided by the communication interface 202 of the merchant device 135 to a communication interface 124 of the payment server 120 and includes the transaction data 306 and an authorization request. In some embodiments, the electronic processor of the merchant device 135 attaches additional data to the second data packet (e.g., transaction data 306) to create a third data packet (e.g., transaction request 308). The process 500 continues to example process 600.

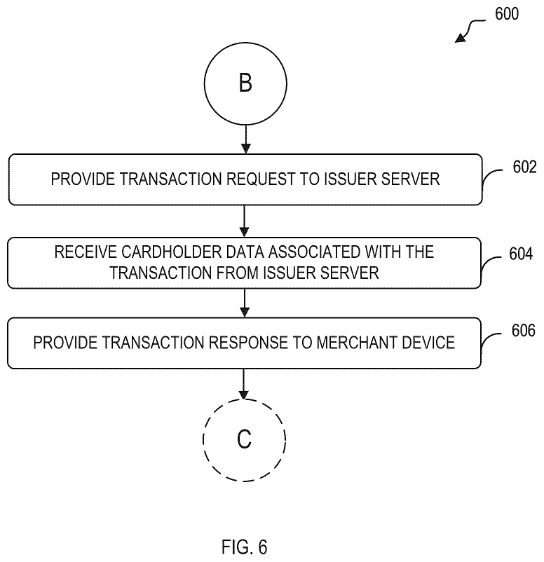

FIG. 6 is a flow diagram illustrating the example process 600 of providing an authorization to a merchant device, such merchant device 135, in accordance with various aspects of the present disclosure. In the example of FIG. 6, the process 600 is described in a sequential flow, however, some of the process 600 may also be performed in parallel. It is understood that the process 600 may be stored in a memory, such as memory 126 of the payment server 120, and executed by a processor, such as electronic processor 122 of the payment server 120. Accordingly, the process 600 is described in regards to payment server 120. In some embodiments, the process 600 may be executed in conjunction with or in response to the steps of process 400 and/or process 500.

The communication interface 124 of the payment server 120 provides a transaction request to the issuer server 104 (block 602). For example, the communication interface 124 sends a fourth data packet including and indicating the transaction request 308 to the communication interface 108 of the issuer server 104. In some embodiments, the payment server 120 automatically provides the fourth data packet (e.g., the transaction request 308) to the issuer server 104 upon receipt of the third data packet from the merchant device 135. In some embodiments, the third data packet and the fourth data packet are the same. Alternatively, in some embodiments, the fourth data packet includes additional data from the third data packet. In some embodiments, payment server 120 includes cardholder data 302 in the memory 126 of the payment server 120 and does not provide the transaction request to the issuer server 104.

The communication interface 124 of the payment server 120 receives cardholder data associated with the transaction from the issuer server 104 (block 604). For example, the communication interface 124 may receive a fifth data packet including a transaction response 312 from the communication interface 108 of the issuer server 104. In some embodiments, the fifth data packet (e.g., the transaction response 312) includes at least one of the cardholder's personal information, an authorization request response, and a notice that the cardholder has sufficient funds for the item. In some embodiments, the fifth data packet is encrypted. In some embodiments, the fifth data packet includes the data from the fourth data packet (e.g., the transaction request 308).

The communication interface 124 of the payment server 120 provides an authorization response to the merchant device 135 (block 606). For example, the communication interface 124 sends the fifth data packet including the transaction response 312 to the communication interface 212 of the merchant device 135. In some embodiments, the payment server 120 adds additional data to the cardholder's personal information included in the fifth data packet before sending the fifth data packet to the merchant device 135. After the cardholder personal information is communicated to the merchant device 135, the process 600 continues to example process 700.

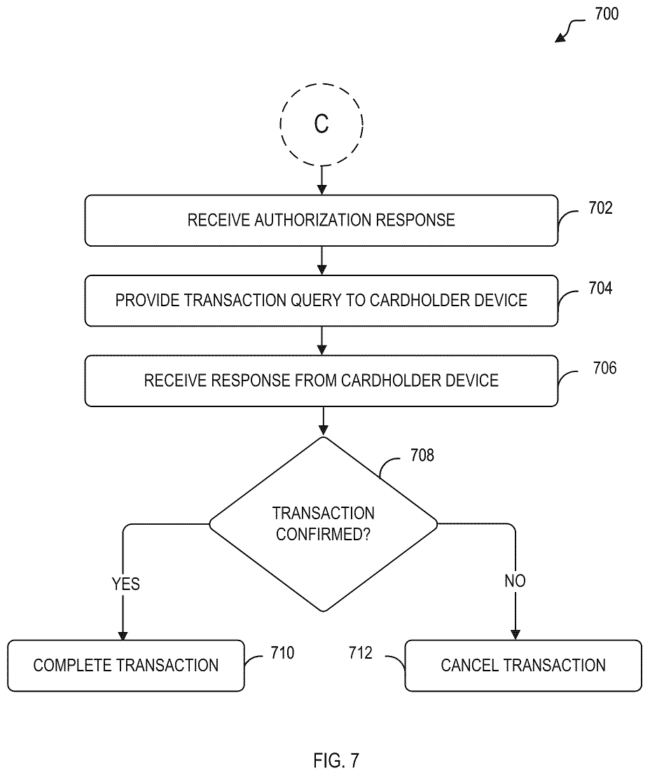

FIG. 7 is a flow diagram illustrating an example process 700 providing a transaction confirmation to a cardholder device, such as cardholder device 130, for fraud prevention, in accordance with various aspects of the present disclosure. In the example of FIG. 7, the process 700 is described in a sequential flow, however, some of the process 700 may also be performed in parallel. It is understood that the process 700 may be stored in a memory, such as memory 216 of the merchant device 135, and executed by a processor, such as electronic processor 210 of the merchant device 135. Accordingly, the process 700 is described in regards to merchant device 135. In some embodiments, the process 700 may be executed in conjunction with or in response to the steps of process 600.

The communication interface 212 of the merchant device 135 receives the authorization response from the payment server 120 (block 702). For example, the communication interface 212 receives the fifth data packet including the transaction response 312 from the communication interface 124 of the payment server 120. The fifth data packet may include cardholder personal information. In some embodiments, the electronic processor 210 of the merchant device 135 parses the fifth data packet to determine a particular element of the cardholder's personal information. For example, the electronic processor 210 may extract at least one of a mobile phone number and email address from the fifth data packet.

The communication interface 212 of the merchant device 135 provides a transaction query to a cardholder device 130 (block 704). For example, the communication interface 212 provides a sixth data packet including the transaction query 314 to the communication interface 202 of the cardholder device 130. In some embodiments, the communication interface 212 may provide the sixth data packet (e.g., transaction query 314) via at least one of an email, text message, phone call, or direct message on a web platform based on the cardholder's personal information.

The communication interface 212 of the merchant device 135 receives a response from the cardholder device 130 (block 706). For example, the communication interface 212 receives a seventh data packet including one of a transaction confirmation 316 or a transaction denial 320 from the communication interface 202 of the cardholder device 130. In some embodiments, a cardholder interacts with the transaction query 314 on the GUI 204 of the cardholder device 130 and the electronic processor 200 of the cardholder device executes the application 208 to create the seventh data packet based on the interaction.

The electronic processor 210 of the merchant device 135 determines whether the transaction is confirmed (at decision block 708). For example, the electronic processor 210 parses the seventh data packet to determine that the seventh data packet includes a transaction confirmation 316 or a transaction denial 320. When the seventh data packet includes the transaction confirmation 316, the process 700 continues to block 710. The electronic processor 210 of the merchant device 135 completes the transaction (block 710). For example, the transaction confirmation 316 may include a common identifier to the transaction data 306 that supports the legitimacy of the transaction between the cardholder device 130 and the merchant device 135. In some embodiments, the communication interface 212 of the merchant device 135 sends the cardholder device 130 an eighth data packet including and indicating a transaction completion 318. For example, the transaction completion 318 may deem the second data packet (e.g., including and indicating the transaction data 306 from the cardholder device 130) legitimate. When the seventh data packet includes the transaction denial 320, the process 700 continues to block 712. The electronic processor 210 of the merchant device 135 cancels the transaction (block 712). For example, the transaction denial 320 may not include the common identifier to the transaction data 306. In some embodiments, the communication interface 212 of the merchant device 135 sends the cardholder device 130 a ninth data packet including a transaction cancellation 319.

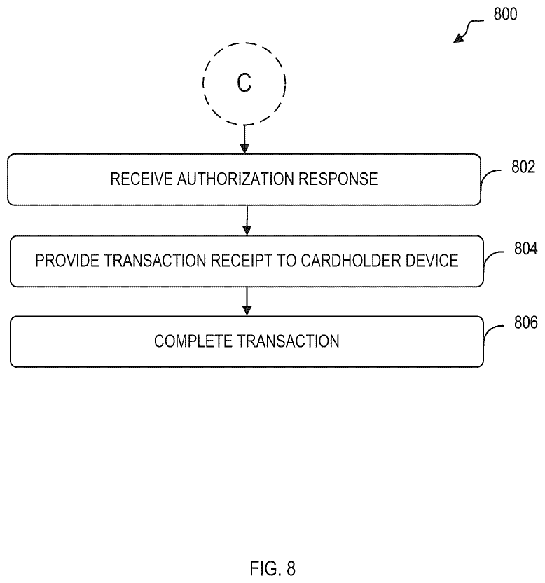

FIG. 8 is a flow diagram illustrating an example process 800 of providing a transaction receipt to a cardholder device, such as cardholder device 130, in accordance with various aspects of the present disclosure. In the example of FIG. 8, the process 800 is described in a sequential flow, however, some of the process 800 may also be performed in parallel. It is understood that the process 800 may be stored in a memory, such as memory 216 of the merchant device 135, and executed by a processor, such as electronic processor 210 of the merchant device 135. Accordingly, the process 800 is described in regards to merchant device 135. In some embodiments, the process 800 may be executed in conjunction with or in response to the steps of at least one of process 600 and process 700.

The communication interface 212 of the merchant device 135 receives the authorization response from the payment server 120 (block 802). For example, the communication interface 212 receives the fifth data packet including the transaction response 312 from the communication interface 124 of the payment server 120. The fifth data packet includes cardholder personal information. In some embodiments, the electronic processor 210 of the merchant device 135 parses the fifth data packet to determine cardholder personal information. For example, the electronic processor 210 may extract at least one of a mobile phone number, an email address, and an electronic receipt preference of the cardholder from the fifth data packet.

The communication interface 212 of the merchant device 135 provides a transaction receipt to a cardholder device 130 (block 804). For example, the communication interface 212 provides a tenth data packet including the transaction receipt 322 to the communication interface 202 of the cardholder device 130. In some embodiments, the communication interface 212 may provide the tenth data packet (e.g., transaction receipt 322) via at least one of an email and text message. The electronic processor 210 of the merchant device 135 completes the transaction (block 806). In some embodiments, the communication interface 212 of the merchant device 135 sends the cardholder device 130 an eleventh data packet including a transaction completion 318.

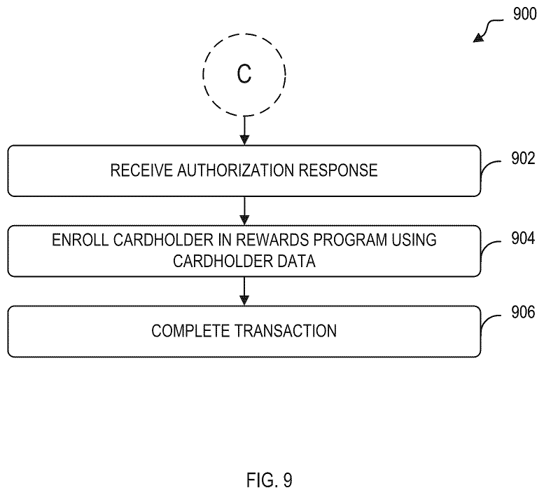

FIG. 9 is a flow diagram illustrating an example process 900 of enrolling a cardholder in a rewards program, in accordance with various aspects of the present disclosure. In the example of FIG. 9, the process 900 is described in a sequential flow, however, some of the process 900 may also be performed in parallel. It is understood that the process 900 may be stored in a memory, such as memory 216 of the merchant device 135, and executed by a processor, such as electronic processor 210 of the merchant device 135. Accordingly, the process 900 is described in regards to merchant device 135. In some embodiments, the process 900 may be executed in conjunction with or in response to the steps of at least one of process 600, process 700, and process 800.

The communication interface 212 of the merchant device 135 receives the authorization response from the payment server 120 (block 902). For example, the communication interface 212 receives the fifth data packet including the transaction response 312 from the communication interface 124 of the payment server 120. The fifth data packet includes cardholder personal information. In some embodiments, the electronic processor 210 of the merchant device 135 parses the fifth data packet to determine cardholder personal information. For example, the electronic processor 210 may extract at least one of a mobile phone number, an email address, and a rewards program enrollment preference of the cardholder from the fifth data packet.

The electronic processor 210 of the merchant device 135 enrolls a cardholder in a rewards program using the cardholder personal information (block 904). For example, the electronic processor 210 may store a phone number and email address of the cardholder in the memory 216 of the merchant device 135 along with an identifier that represents the cardholder. In some embodiments, the electronic processor 210 may store the personal information in a section of the memory 216 dedicated to cardholders enrolled in the rewards program. The electronic processor 210 of the merchant device 135 completes the transaction (block 906). In some embodiments, the communication interface 212 of the merchant device 135 sends the cardholder device 130 a twelfth data packet including a transaction completion 318 and notice that they were enrolled in the rewards program.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It should thus be noted that the matter contained in the above description or shown in the accompanying drawings is to be interpreted as illustrative and not in a limiting sense.

What is claimed is:

1. A system for communicating cardholder data, the system comprising:
a remuneration vehicle device including a first communication interface, a first electronic processor, and a first memory;
a third-party entity device including a second communication interface, a second electronic processor, and a second memory; and
a server including a third communication interface, a third electronic processor, and a third memory, the third electronic processor configured to:
receive, with the third communication interface, a first data packet indicating cardholder data from the first communication interface,
store the cardholder data in the third memory,
receive, with the third communication interface, a second data packet indicating a transaction request from the second communication interface, and
provide, with the third communication interface, a third data packet indicating a transaction response to the second communication interface,
wherein the third data packet includes the cardholder data from the third memory.

2. The system of claim 1, wherein the first data packet includes at least one of a cardholder phone number, a cardholder email address, a cardholder receipt preference, and a cardholder rewards enrollment preference.

3. The system of claim 1, wherein the server is one of a payment processor server and an issuer server.

4. The system of claim 1, wherein the third data packet is encrypted by the third electronic processor.

5. The system of claim 1, wherein the remuneration vehicle device, the third-party entity device, and the server communicate over a network.

6. The system of claim 1, wherein the second electronic processor is configured to:
receive, with the second communication interface, the third data packet,
provide, with the second communication interface, a fourth data packet to the first communication interface, and
receive, with the second communication interface, a fifth data packet from the first communication interface.

7. The system of claim 6, wherein the second electronic processor is further configured to:
determine that the second data packet was fraudulent based on the fifth data packet, and
cancel a transaction from the remuneration vehicle device associated with the second data packet.

8. The system of claim 6, wherein the second electronic processor is further configured to:
determine that the second data packet was legitimate based on the fifth data packet, and
provide, with the second communication interface, a sixth data packet including a transaction confirmation to the first communication interface.

9. The system of claim 1, wherein the third electronic processor is further configured to:
match, in response to receiving the second data packet, data of the second data packet with data of the first data packet in the third memory to determine the third data packet.

10. A method for communicating cardholder data from a server to a third-party entity device, the method comprising:
receiving, with a communication interface of the server, a first data packet from a communication interface of a remuneration vehicle device,
storing, with an electronic processor of the server, the first data packet in a memory of the server,
receiving, with the communication interface of the server, a second data packet from a communication interface of the third-party entity device, and
providing, with the communication interface of the server, a third data packet to the communication interface of the third-party entity device,
wherein the third data packet includes the first data packet and additional data from the memory of the server.

11. The method of claim 10, further comprising:
receiving, with the communication interface of the third-party entity device, the third data packet, and
providing, with the communication interface of the third-party entity device, a fourth data packet to the communication interface of the remuneration vehicle device based on the third data packet including a first data.

12. The method of claim 11, wherein the first data is an electronic receipt preference, and
wherein the fourth data packet includes an electronic receipt for a transaction between the remuneration vehicle device and the third-party entity device.

13. The method of claim 10, further comprising:
receiving, with the communication interface of the third-party entity device, the third data packet, and
enrolling, with an electronic processor of the third-party entity device, a cardholder in a rewards program based on the third data packet including a first data.

14. The method of claim 13, wherein the first data is an enrollment preference.

15. The method of claim 10, wherein the server is one of a payment processor server and an issuer server.

16. A non-transitory computer-readable medium comprising instructions for communicating cardholder data to a third-party entity device that, when executed by an electronic processor, cause the electronic processor to perform a set of operations comprising:
receiving, with a communication interface of a payment processor server coupled to the electronic processor, a first data packet from a communication interface of the third-party entity device,
providing, with the communication interface of the payment processor server, the first data packet to a communication interface of an issuer server,
receiving, with the communication interface of the payment processor server, a second data packet from the communication interface of an issuer server, and
providing, with the communication interface of the payment processor server, a third data packet to the communication interface of the third-party entity device,
wherein the third data packet includes the second data packet and additional data associated with the issuer server stored in a memory of the payment processor server.

17. The non-transitory computer-readable medium of claim 16, wherein the first data packet includes a transaction request.

18. The non-transitory computer-readable medium of claim 16, wherein the second data packet includes at least one of a cardholder phone number, a cardholder email address, a cardholder receipt preference, and a cardholder rewards enrollment preference.

19. The non-transitory computer-readable medium of claim 16, wherein the second data packet is received from a remuneration device and stored in a memory of the issuer server.

20. The non-transitory computer-readable medium of claim 16, wherein the payment processor server, issuer server, and third-party entity device communicate over a network.
